(19) United States
(12) Patent Application Publication
(10) Pub. No.: US 2009/0113715 A1
(43) Pub. Date: May 7, 2009

(54) Safety razor head assembling with diagonal blades

(76) Inventor: Alfonso Goss-Meléndez, Caguas, PR (US)

Correspondence Address: EUGENIO J. TORRES, 221 PLAZA BUILDING, PONCE DE LEON, SUITE 403, SAN JUAN, PR, 00917, US

(21) Appl. No.: 11/935,826

(22) Filed: Nov. 6, 2007

(51) Int. Cl. B26B 21/00

(52) U.S. Cl. 30/50

(57) ABSTRACT

The invention is directed to a safety shaving razor comprising a detachable cartridge provided with angled blades with tension members between blades connected to a handle by coupling means. The blades are arranged in such manner that at least three different angled cuts across the razor head face is provided per stroke for an easier, closer and smoother shave.

### RELATED APPLICATIONS

N/A

### BACKGROUND OF THE INVENTION

1. Field of the Invention

This invention relates to safety shaving razors and more particularly to the coupling of a razor head to a shaving handle wherein the razor head comprises angled blades with tension members between blades for a closer and smoother shave.

2. Discussion of the Background

The uses of razors as shaving instruments are well know and are in common use. The ordinary razor has one or multiple blades arranged at the longitudinal axis of the shaving razor's head providing a chopping motion over the hair. Other razors are provided with angular blades for a slicing motion reducing the force required for cutting, prolonging the blade's life and providing a cleaner and less tearing cut. For example, Byrne (U.S. Pat. No. 4,854,042) discloses a diagonal blade cartridge having three razor blades wherein the first blade is in angular relation to a second and third blade and these two last blades are parallel to each other. The three razors are covered with a cap made of thermoplastic which is assembled with a base portion in order to hold said blades. This arrangement however provides just one diagonal direction cut and the cap, which contacts the skin face, but does not provide good skin tension making the skin-flow poor.

### SUMMARY OF THE INVENTION

The present invention overcomes the disadvantages of the Prior Art by providing a razor having multiple blades wherein at least more than two diagonal blades transverse each other having a rubber material placed between the blades in order to provide tension to the skin for a closer and smoother shave.

Accordingly, one object of the invention is to provide coupling means for a safety and easier method to adjust the razor's head and the razor's handle.

Another object of the invention is the extension of the diagonal blade across the razor's head for a greater area of contact per stroke.

Yet another object of the present invention is to cross the blades in order to reduce the height of the razor head face, which is the portion of the razor head that contacts the face, while increasing the diagonal blade area per stroke.

The invention itself, both as to its configuration and its mode of operation will be best understood, and additional objects and advantages thereof will become apparent, by the following detailed description of a preferred embodiment taken in conjunction with the accompanying drawing.

The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying drawings which are incorporated herein constituted part of the specifications and illustrate the preferred embodiments of the invention.

FIG. 1 is a front view of the razor.

FIG. 2 is an isometric back view of the razor

FIG. 3 is an isometric front view of the razor

FIG. 4a is a top view of the razor.

FIG. 5 is back view of the razor.

FIG. 6a is a view of the preferred embodiment of the razor's head.

FIG. 6b is a view of a second embodiment of the razor's head.

FIG. 6c is a view of a third embodiment of the razor's head.

FIG. 7a is a first blade top view of the third embodiment.

FIG. 7b is a first blade side view of the third embodiment.

FIG. 8a is a second blade top view of the third embodiment.

FIG. 8b is a second blade side view of the third embodiment.

FIG. 9a represents the assembling of the third embodiment.

FIG. 9b represents the cutting directions per stroke.

FIG. 10a is an isometric view of the preferred embodiment razor head with skin tension members.

FIG. 10b is an exploded view of Section I on FIG. 10a.

FIG. 10c is an exploded side view of Section I on FIG. 10a.

FIG. 10d is an isometric view of the razor head with skin tension with holding members.

FIG. 10e is an exploded view of the razor head holding members.

FIG. 11a is an isometric view of a loaded coupling mean.

FIG. 11b is an isometric view of an unloaded coupling mean.

FIG. 12a is an inner isometric view of load coupling means.

FIG. 12b is an inner isometric view of unload coupling means.

FIG. 13a is an exploded view of section IIII—-FIG. 11a.

FIG. 13b is an exploded view of section IV—FIG. 11b.

FIG. 14a is a view of an unloaded locking mean.

FIG. 14b is a view of a loaded locking mean.

FIG. 15a is a view of an unloaded locking mean with cartridge.

FIG. 15b is a view of a loaded locking mean with cartridge.

### DESCRIPTION OF THE PREFERRED EMBODIMENT

The present invention relates to safety shaving razors and more particularly to the coupling of a razor's head to a shaving handle wherein the razor head comprises angled blades with tension members.

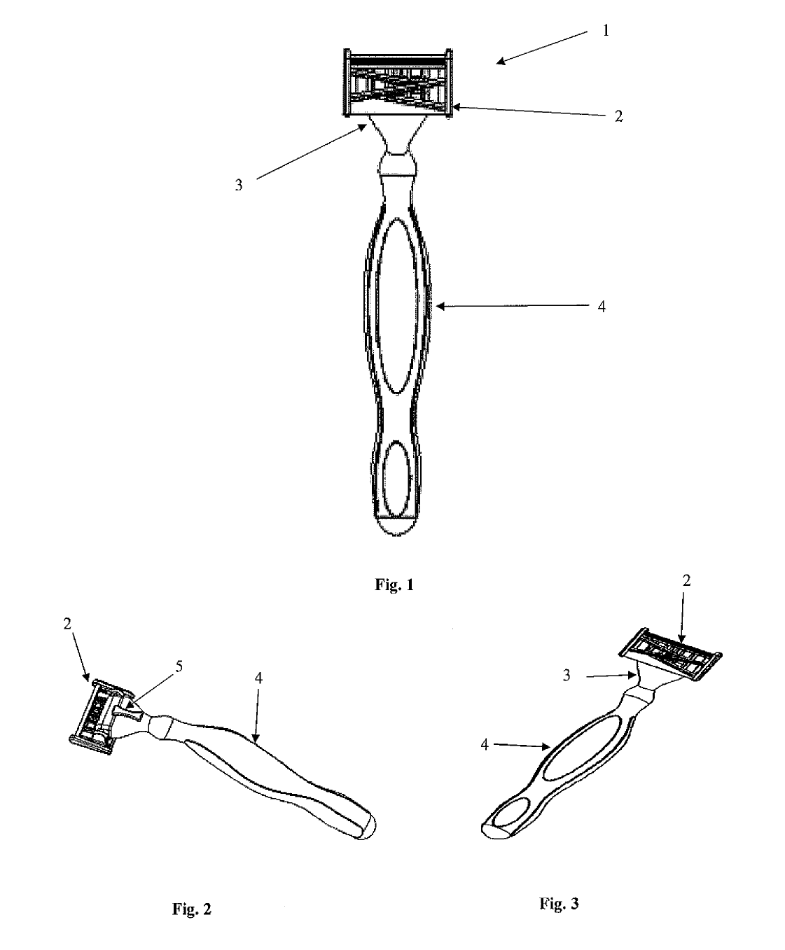

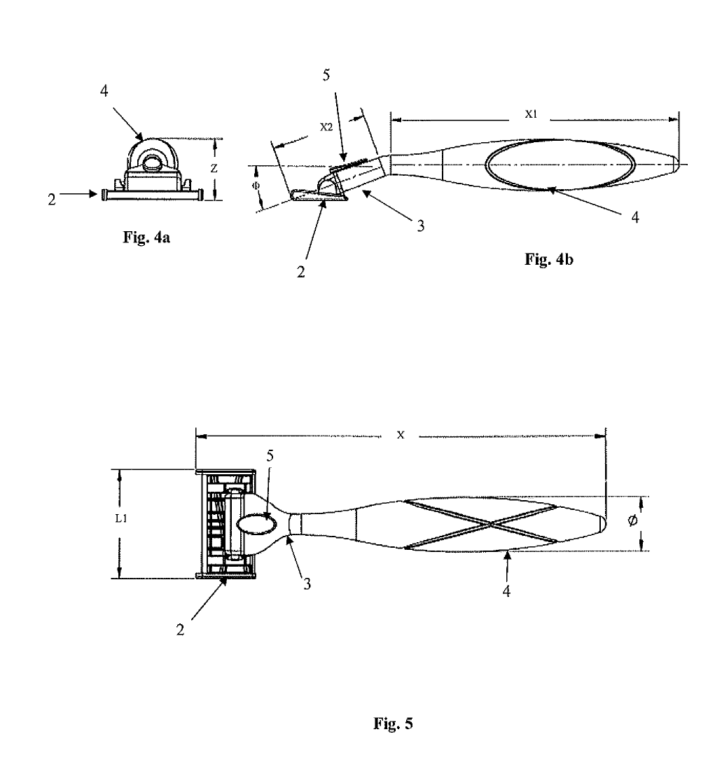

FIGS. 1-6 shows a razor (1) comprising a razor head cartridge (2) with blades (9-11) connected to a distal end of the razor handle (4) by coupling means (3). The razor head is separable from the handle by a release button (5) which controls the releasing and fastening of said razor head (2). The size of the razor head, coupling means and handle may vary depending on the design. In the preferred embodiment dimensions the handle (4) has a length of approximately 4.5 inches and the distance between the coupling means and the razor head (2) is approximately 1.49 inches with an angle (Φ) of 20 degrees from the handle axis. The height (z) between the razor head (2) and the handle (4) is approximately 0.95 inches and the total length (x) of the razor is 6.06 inches, wherein the razor width (L1) is approximately 1.59 inches.

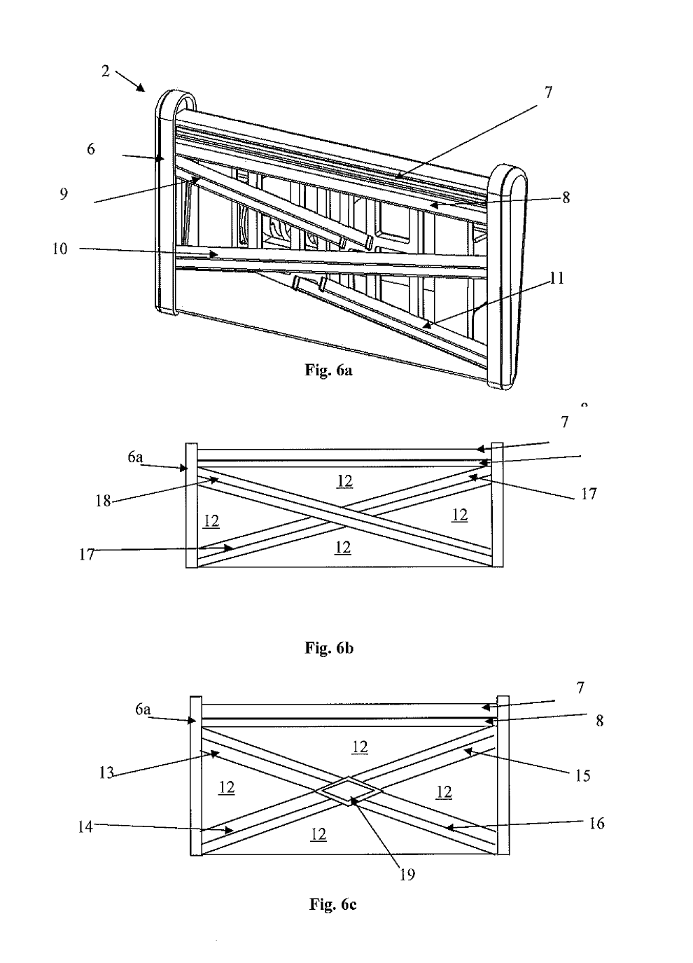

The razor head (2) comprises several angled blades arrangements (8, 9, 10, 11, 13-18) as part of the preferred embodiments for the razor head. The preferred embodiment for the razor's head (2), as show in FIG. 6a, comprises a frame (6), a lubricating band (7), skin-tension member (12) and four blades (8-11). At least two blades extend across the razor's head (2) face, wherein the first blade (8) extends at the longitudinal axis of the shaving razor's head providing a chopping motion over the facial hair and a second angled blade (10) is diagonal to the longitudinal axis for a slicing motion. The third (9) and fourth (11) blades are parallel to each other and angled with an opposing slicing direction compared with the second blade. The second angled blade (10) is positioned between the third (9) and fourth blade (11); however the cutting area covered by the third (9) and fourth (11) blade is extended across the razor head face. Consequently the same hair (H) may have at least three different cutting directions per stroke as show in FIG. 9b.

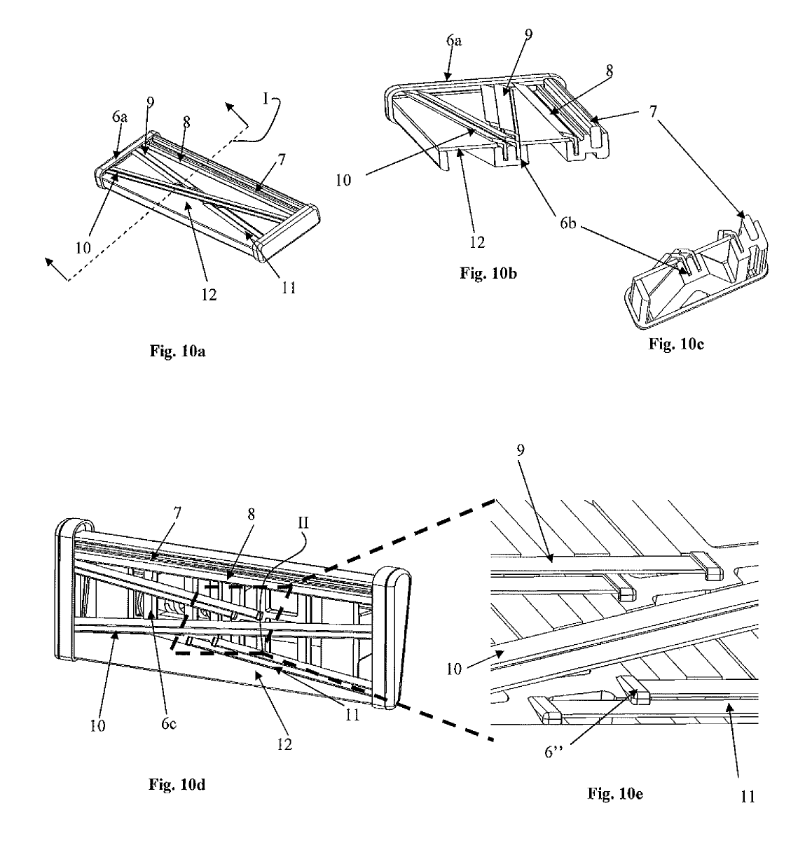

FIGS. 10a-10e show the frame structure (6) and fixing means for the blades. The first method to hold the blades consist in providing a frame as shown in FIGS. 10a-10c with multiple groves (6b), wherein the blades are inserted and fixed. When the blade is inserted in the groove or channel (6b) a portion of the blade is inside the groove while the other portion of the blade is outside of the groove and bent approximately perpendicular to the first portion in favor of the stroke motion (S). The frame (6) has at least 3 angled grooves holding the second, third and fourth blade respectively. The razor head lateral distal ends (6a) cover at least one of the blades' extremities and fix the blades in position. For example, the first (8) and second (10) blades extremities are supported with both lateral distal ends (6a). The extremities of the third (9) and forth blade (11) is supported by different lateral distal ends (6a) and the grooves (6b).

FIGS. 10d and 10e show a second method for holding the blades. The frame (6) comprises two lateral distal ends (6a) as mentioned before with holding portions (6″) which could be integrally formed with the frame structure (6). The main body (6c) is a framework with open spaces, instead of a solid framework with grooves or channel for fixing the blades across the main body (6c), providing a less rigid structure. The rigidity of the frame (6) may vary depending on the distance between open spaces. As mentioned before the first (8) and second (10) blades extremities are supported with both distal ends of frame (6a). The extremities of the third (9) and fourth blade (11) are supported by different lateral distal ends (6a) and the holding members (6″) which are angled, located at a distal end of said third and forth blade, and fixed to the cartridge frame main body (6c). The structure reduces the material used, frame's thickness and provides support for the blades and the tension skin members (12).

The tension members (12) also supported by the frame structure (6) are located between blades in order to stretch the skin at the stroke before the hair (H) is cut. The combination of the stretching and multiple slicing direction shave per stroke provides an easier, smoother and closer shave.

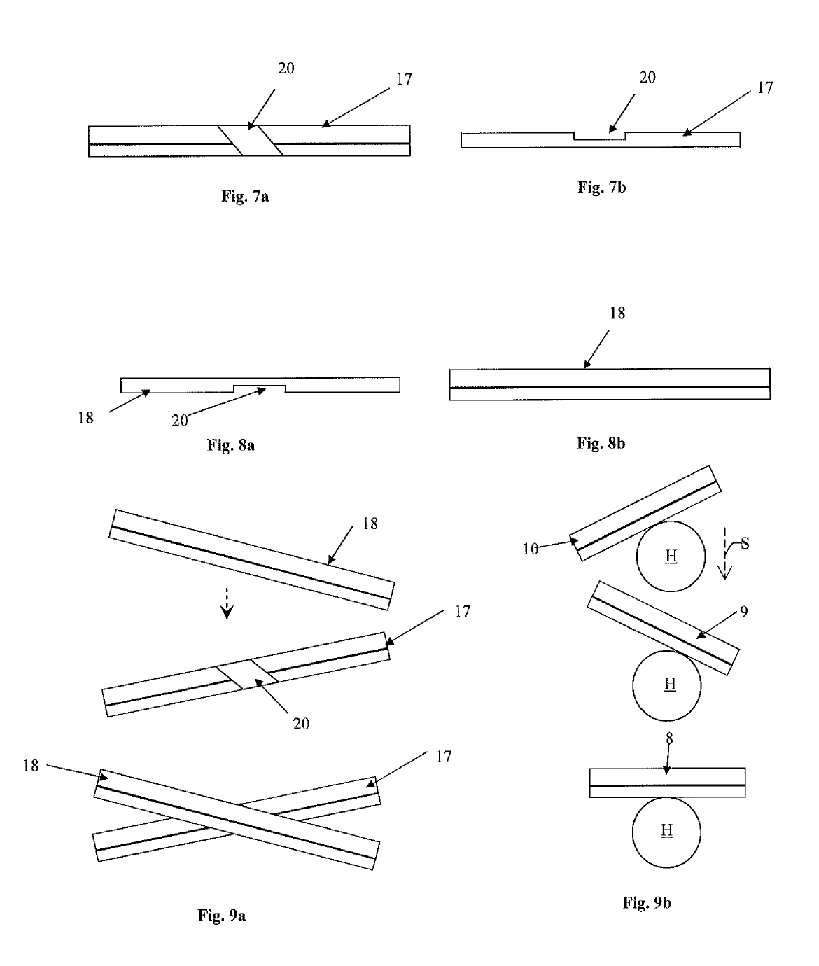

The second embodiment for the razor head, as show in FIG. 6b, is a combination of at least three blades (8, 17, 18) wherein the first blade (8) is positioned longitudinal to the razor head (2) face providing a chopping motion over the hair (H), the second and third blade are placed diagonally (17, 18) for a slicing motion across the razor head face. The diagonal blades combination has an X-shape. At the point of intersection between these two blades, each blade's thickness is reduced, as shown in FIGS. 7a-8b, at least a half. The groove (20) form in the middle of each blade has a selected angle, wherein the groove is at the top of one of the diagonal blades and at the bottom of the other diagonal blade. Since the thickness is reduced a tougher material may be provided at the grooves (20) preventing it from braking. The tougher material can be integrally formed with the blade. FIG. 9 present's the assembling method of the second and third diagonal blades wherein the groove (20) on the second blade (18) fits the groove (20) on the third blade (17) providing an X-shape. The assembling reduces the height of the razor head face while increasing the diagonal blade area per stroke.

Yet another embodiment for the razor head is shown in FIG. 6c. The third embodiment comprises at least five blades, wherein a first, as mentioned before, blade (8) is positioned longitudinal to the razor head (2) face providing a chopping motion over the hair (H) as mentioned before. Similar to the other two embodiments, the third embodiment has multiple slicing directions across the razor head face. Each blade is diagonal positioned having one extremity connected to the lateral distal ends (6a) and the other extremity connected to a center holding portion (19) which assists to fix the blades (13-16). A tension member (12) is provided between the blades as similar to the other two embodiments.

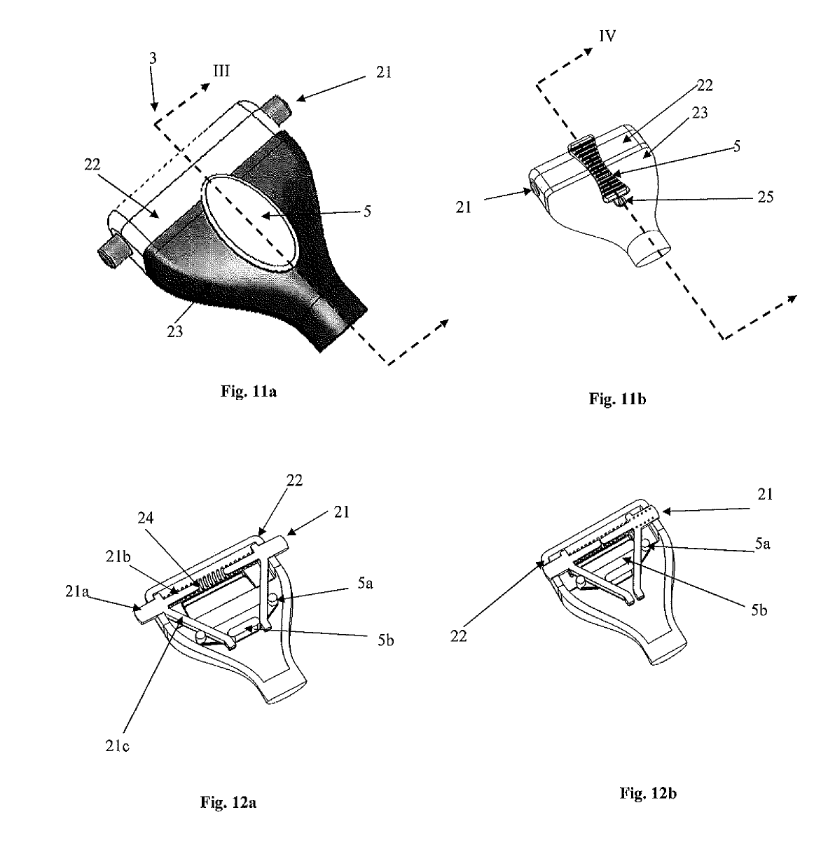

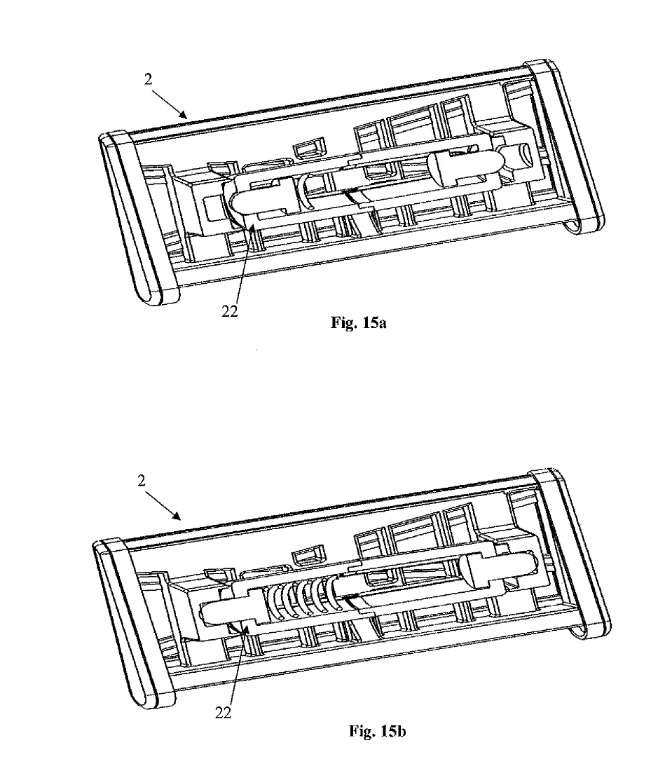

The razor head cartridge (2) is connected to a handle (4) at a distal end by coupling means (3). The coupling means (3), as shown in FIGS. 11a-14b, consists of a casing (23), a release button (5) and locking mean (22), wherein said locking mean (22) comprises a housing (22a), press arms (21c), a spring (24), locking protrusions (21) and a sliding plate (5b) connected to the release button (5). FIG. 11a and FIG. 15b discloses the detachable cartridge (2) at a load position with the coupling mean (3) wherein outer protrusions (21a) lock the razor head cartridge and limit its movement. The outer protrusion (21a) may have different shapes, for example a cylindrical shape, as long as it works as a pivot for the razor head (2). At the load position the spring (24), as its equilibrium position, pushes the outer protrusion portion (21a) outside the housing (22a) while inner protrusions portion (21b) remains inside the housing (22a) surrounded by the spring (24).

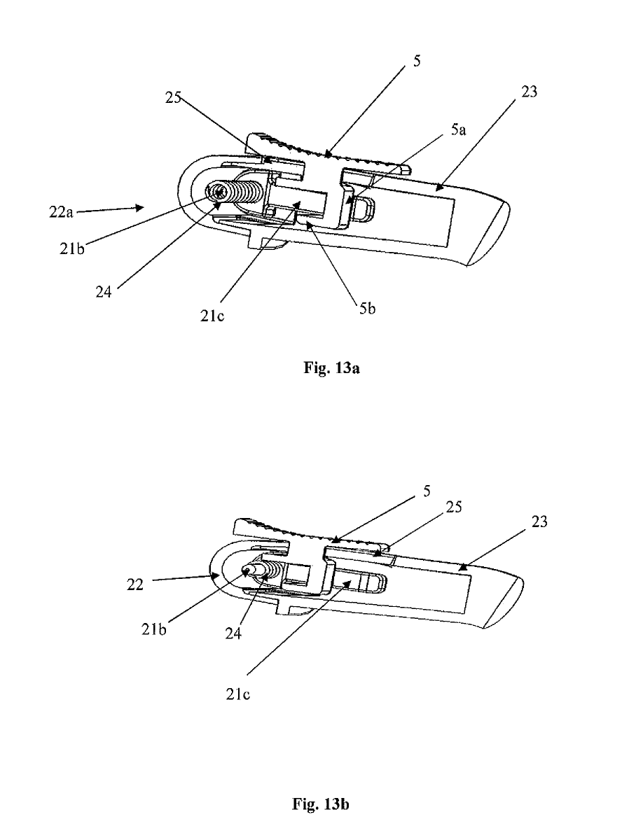

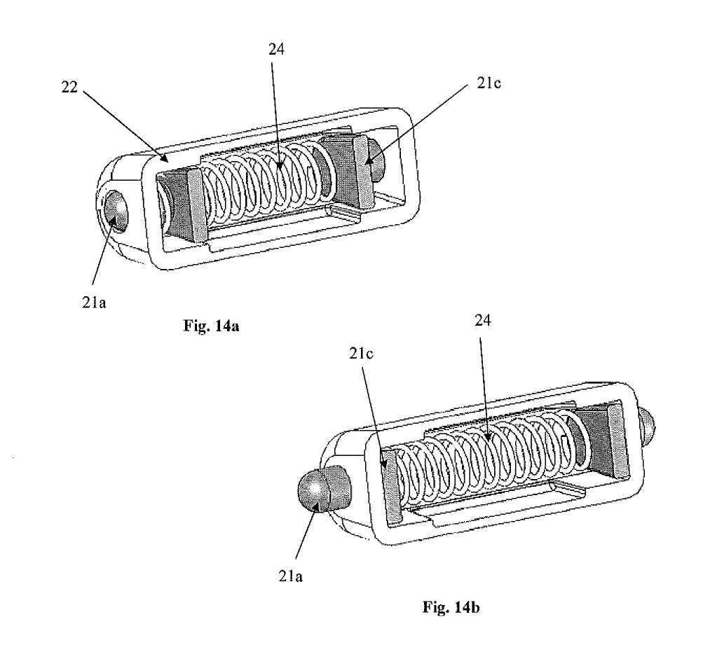

As shown in FIG. 12a the protrusions (21) are connected or integrally made with the arm press (21c), which is made of a flexible material. The arm press (21c) transmits the movement applied by the spring (24) toward the release button (5) and vice versa. Basically at the load position the spring (24) pushes the protrusion outside of the housing (22a), as mentioned before, and the arm press (21c) transmits the movement toward the sliding plate (5b) which is integrally made or connected to the release button (5), as shown in FIGS. 13a-13b. The release button (5) is pushed away from the housing (22a) while the razor head is held by the outer protrusions (21a).

In case the razor head (2) needs to be removed the coupling mean (3) is shifted to an unload position, as shown in FIG. 15a. The unload position, as shown in FIG. 11b, consist in the movement of the release button (5) toward the housing (22a). The displacement of the release button (5) is transmitted to the press arm (21c) by the sliding plate which is provided with perpendicular extensions (5a) that bend and control the press arms' (21c) displacement for the movement of the protrusions (21). The final result is the movement of the outer protrusion (21a) inside the housing (22a) releasing the razor head (2) while the spring (24) is compressed. A channel (25) as a rail for the release button (5) is provided at the top of the casing (23). Also the inner protrusion (21b) extends inside the spring (24) in order to avoid any unwanted displacement of said spring (24). For example FIGS. 11a,12a and 13a show the coupling means (3) at the load position and FIGS. 11b,12b and 13b show the movement of the release button at the unload position.

Furthermore in order to control the displacement of the spring (24), the protrusions (21) and the press arms (21c) at the unload and load position the inner section of said housing (22) and casing (23) are shaped to fit each element and allow just a limited part displacement, as shown in FIGS. 14a and 14b.

While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

1. A razor comprising:
a handle,
a detachable razor head cartridge coupled to a distal end of said handle by coupling means;
wherein said razor head cartridge comprises at least two diagonal blades and at least three different angled cut extended across the razor head face;
wherein tension members are located between blades.

2. A razor as in claim 1, wherein said at least two diagonal blades comprise a groove which connects the blades at the middle of said cartridge providing an X-shape.

3. A razor as in claim 1, wherein said razor blade cartridge blade comprises a frame with channel for fixing the blades.

4. A razor as in claim 1, wherein said at least two diagonal blades are fixed to a cartridge frame by angled holding members located at a distal end of the blades.

5. A razor as in claim 1, wherein said coupling means comprises:
a casing,
a release button,
locking means,
wherein said locking means are mechanically connected to said release button, and comprises a housing, press arms, a spring, locking protrusions and a sliding plate integrally formed with the release button.

6. A razor as in claim 2, wherein the method for replacing the razor head cartridge comprises the steps of:
pushing the release button in a pre-determined direction
the sliding plate moving the pressed arms as a result of the release button pushing direction.
the pressed arm, which is integrally formed with protrusions, compresses the spring.
the part of the protrusion which contact the cartridge moves as a result of the release button and sets free the cartridge.
replacing the cartridge.
setting free the release button until the protrusions and the cartridge are coupled.
